(19) United States
(12) Patent Application Publication
(10) Pub. No.: US 2013/0219618 A1
(43) Pub. Date: Aug. 29, 2013

(54) MULTI-LAYER NON-ABSORBENT BED PAD MADE FROM NON-WOVEN MATERIAL

(71) Applicant: Martin J. Rotter, Glenside, PA (US)

(72) Inventor: Martin J. Rotter, Glenside, PA (US)

(21) Appl. No.: 13/774,740

(22) Filed: Feb. 22, 2013

Related U.S. Application Data
(60) Provisional application No. 61/602,133, filed on Feb. 23, 2012.

(51) Int. Cl. A47G 9/02; D05B 23/00; G09F 3/00; D04H 18/00

(52) U.S. Cl. CPC A47G 9/02; D04H 18/00; D05B 23/00; G09F 3/00
USPC 5/502; 28/107; 112/475.01; 40/299.01; 156/62.8

(57) ABSTRACT

A bed pad and a method for constructing a bed pad are disclosed. The bed pad comprises a first mat and a second mat, wherein the first mat is constructed of randomly aligned synthetic fibers which are opened and blended, randomly aligned into a web by airflow, joined by water based phenolic or latex binding agents and heat cured to produce an air-permeable varying mesh, the first mat being of unitary sheet construction and having a first stiffness and the second mat, cooperative with the first mat, is constructed of randomly aligned synthetic fibers which are opened and blended, randomly aligned into a web by airflow, joined by water based phenolic or latex binding agents and heat cured to produce an air-permeable varying mesh, the second mat being of unitary sheet construction and having a second stiffness less than the first stiffness.

### CROSS REFERENCE TO RELATED APPLICATIONS

This application claims the benefit of U.S. provisional application No. 61/602,133 filed Feb. 23, 2012, the contents of which is hereby incorporated by reference herein. This application is related to U.S. Pat. No. 5,484,641, issued Jan. 16, 1996, which is hereby incorporated by reference.

### FIELD OF INVENTION

The disclosure herein relates to multilayer non-absorbent bed pads made from non-woven material.

### BACKGROUND

With modern advances in health care, the average life span for individuals is increasing. Along with this, increasing numbers of people are hospitalized or spend long periods in convalescent care and nursing home facilities. This invention addresses two major problems faced by those patients and facilities: (1) varying degrees of urinary incontinence experienced by a high percentage of patients; and (2) pressure sores, rashes and chafing resulting from prolonged confinement in bed.

In some cases, perhaps many, the urinary incontinence problem may be a causative factor for bed sores among nursing home patients who, because of staff shortages, may lie unattended for long periods of time. This could lead to further health problems.

It is clear that moisture and lack of air flow are major contributing factors to pressure sores and other skin disorders associated with long-term confinement in bed. Therefore, it would be desirable to provide a bed pad to create a healthier, dry environment next to a patient's body.

### SUMMARY

In an aspect the invention relates to a bed pad, method of making the bed pad, and systems including the bed pad or parts of the bed pad. The bed pad comprises a first mat and a second mat. The first mat is constructed of randomly aligned synthetic fibers which are opened and blended, randomly aligned into a web by airflow, joined by water based phenolic or latex binding agents and heat cured to produce an air-permeable varying mesh. The first mat is of unitary sheet construction and having a first stiffness. The second mat, cooperative with the first mat, is constructed of randomly aligned synthetic fibers which are opened and blended, randomly aligned into a web by airflow, joined by water based phenolic or latex binding agents and heat cured to produce an air-permeable varying mesh. The second mat is of unitary sheet construction and having a second stiffness less than the first stiffness.

### BRIEF DESCRIPTION OF THE DRAWINGS

FIG. 1 is an exploded view of a multi-layer bed pad installed on a bed.

FIG. 2 is an exploded view of the two layers of an embodiment of the bed pad shown in FIG. 1.

FIG. 3 is a cross-sectional view of the assembled multi-layer pad of FIG. 2.

FIG. 4 is a cross-sectional view of an alternate configuration of the bed pad according to the invention.

### DETAILED DESCRIPTION

Embodiments of the present invention will be described with reference to the drawing figures where like numerals represent like elements throughout. Certain terminology is used in the following description for convenience only and is not limiting. The words “right,” “left,” “top,” and “bottom” designate directions in the drawings to which reference is made. The words “a,” and “one,” as used in the claims and in the corresponding portions of the specification, are defined as including one or more of the referenced item unless specifically stated otherwise. This terminology includes the words above specifically mentioned, derivatives thereof, and words of similar import. The phrase “at least one” followed by a list of two or more items, such as “A, B, or C,” means any individual one of A, B or C as well as any combination thereof.

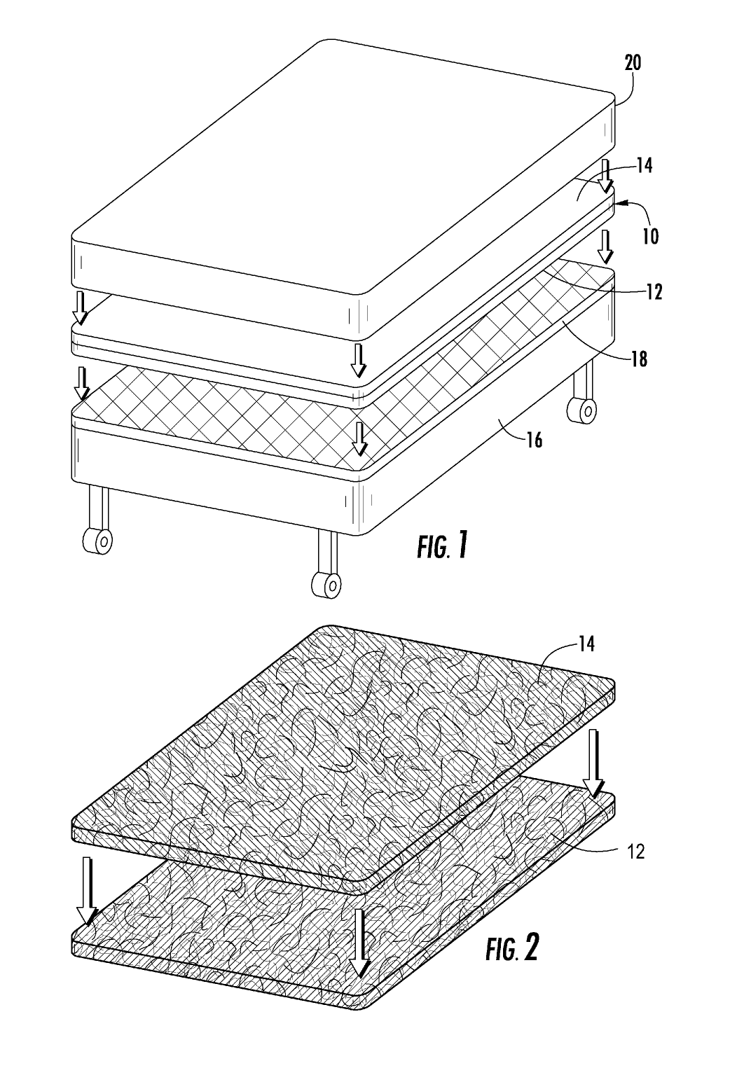

Referring to FIGS. 1-3, an embodiment 10 is shown. The non-absorbent bed pad 10 may be 60″-90″ in length and 30″-50″ in width and comprises a stiff non-woven mat 12 and a soft non-woven mat 14. Stiff non-woven mat 12 and soft non-woven mat 14 may be stacked upon each other without being fixed to one another. Fibers within the material of the mats may include fibers that interlock between one mat and another. Alternatively, stiff non-woven mat 12 and soft non-woven mat 14 may be connected together. Any suitable connection may be utilized. The connection may be through an adhesive. The connection may be through stitching

In an embodiment, stiff non-woven mat 12 can be interchanged with other stiff non-woven mats of different stiffness and the soft non-woven mat 14 can be interchanged with other soft non-woven mats of different softness. The combination of stiff non-woven mat 12 and soft non-woven mat 14 can be adjusted to meet the specific needs of the patient who will be using the non-absorbent bed pad 10. Achievement of various degrees of stiffness or softness of the non-woven mats 12, 14 can result from, but are not limited to, the density of the non-woven fibers in conjunction with the degree of cross linking of the non-woven fibers, the materials that the mats are made from, the addition of other support enhancing materials (for example, the addition of at least one support pin), the configuration of the non-woven pad (for example, a specific structural configuration or the addition of a support structure), or any combination thereof.

One or more anti-microbial agent of the type known to those skilled in the art may be uniformly applied to or within the fibers of one or more of the mats 12, 14. The one or more anti-microbial agent may be within the fibers of one or more of the mats. The one or more anti-microbial agent may include at least one of an anti-fungal agent, an anti-bacterial agent, an anti-protozoan agent, or an anti-parasitic agent. The anti-microbial activity of the anti-microbial agent can be to kill or prevent the growth of the microorganism. An anti-microbial agent may be selected from antiseptics, microbicides, bactericides, and fungicides. An anti-microbial agent may be selected from substances that inhibit the growth of microbial, bacterial, fungal, or parasitic organisms. The one or more anti-microbial agent may be at least one of 10, 16-oxybisphenoxy arsine (OBPA), n-(trichloro-methylthio)phthalimide, 2-n-octyl-4-isothiazolin-3-one, N-trichloro-methylthio-4-cyclohexene-1,2-dicarboximide (Captan), N-(trichloromethylthio) phthalimide (Folpet), amine-neutralized phosphate, or zinc 2-pyidinethiaol-1-oxide. An anti-microbial agent may be an agent that is effective to prevent, reverse, or stop the accumulation of organisms in a film on a non-woven mat or within the non-woven mat. An anti-microbial agent of the one or more anti-microbial agent herein is not limited to the specific agents listed above, and may be any suitable material capable of performing one or more of the above described functions.

As shown in FIG. 2, both mats 12, 14 are made of randomly aligned synthetic fibers joined by water based phenolic or latex binding agents and heat cured to provide a varying mesh having a large net free area. Each individual mat 12, 14 may be made of unitary sheet construction having no dissimilar sheets laminated or otherwise bonded together. Soft non-woven mat 14 may have a finer denier to provide a soft surface, for example, like velvet.

In order for the soft non-woven mat 14 to have a soft surface, several options may be used that include but are not limited to needling longer fibers into the surface of the mat, incorporating silicone into the fibers, adding a lubricant to the surface, adding silicone to the surface, and coating the mat with a smooth surface.

The mats 12, 14 can also be made from a variety of other materials or combinations of materials. For example, there are many consumer and industrial products that create waste. However, some post-consumer and post-industrial waste plastics can be removed from the waste chain by recycling. In an embodiment, a non-absorbent bed pad 10 can be constructed of fibers made up from at least one of recycled post-consumer plastics or recycled post-industrial plastics. Such a bed pad may be referred to as a recycled bed pad. The binder system may be adjusted to achieve proper cross linking. An embodiment may also include at least one anti-microbial agent in the binder system.

Bed pads with biodegradable properties could reduce waste. An embodiment includes a pad constructed of biodegradable fibers. Such a bed pad may be referred to as a green bed pad. Biodegradeable fibers may be starch based. The sources of starch may be but are not limited to, soy-bean, corn, sugar cane, grass, potatoes or beets. The binder system may be adjusted to achieve proper cross linking. The binder may also be a biodegradable material. The binder may be starch or starch based. The sources of binder starch may also be soybean, corn, sugar cane, grass, potatoes or beets. Green bed pads may include at least one anti-microbial agent.

One or more support pin 15 may be provided in stiff non-woven mat 12. The support pin may be configured similar to the plastic reinforcing described in U.S. Pat. No. 5,484,641, which is incorporated herein by reference as if fully set forth. Briefly, a support pin may be a plastic reinforcing pin placed into non-woven filamentary material of a stiff non-woven mat.

A process of placing a support pin into a stiff non-woven mat may be any known in the art. As a non-limiting example, the process of placing a support pin in a stiff non-woven mat may include the steps of: (a) providing an elongated web of randomly-aligned synthetic fibers, (b) creating a repeating pattern of holes through the web by a hole-punching mechanism having a plurality of heated punch heads maintained at a temperature above the melting point of the synthetic fibers, (c) conveying the web from the punching mechanism over a supporting belt such that the belt provides a closed bottom for each hole, (d) injecting a quick-setting liquid polymer into the holes with an injector mechanism having a plurality of liquid injector nozzles arranged in an identical pattern as the pattern of punch heads and operated in coordinated sequence with the punching mechanism, such that an injector nozzle is inserted into a corresponding hole, and (e) allowing the liquid polymer to flow around the severed ends of the fibers to imbed said ends into the polymer as it sets. The liquid polymer may be created by mixing a quick-setting liquid resin and a cross-linking or other hardening agent just prior to injection into the holes and supplying the mixture to each nozzle.

The number of support pins in a stiff non-woven mat may be selected based on the size and weight of the patient that will be on the bed pad 10. A bed pad 10 intended for a 30 lb patient may not require any support pins to be suitably supportive of the patient. A bed pad 10 intended for a 300 lb patient may have several support pins in order to form a non-collapsible surface and be suitably supportive of the patient. Support pins may be randomly located within a stiff non-woven mat 12. Support pins may be dispersed evenly through a stiff non-woven mat 12. Support pins may be located in positions within stiff non-woven mat 12 under where a patient's body is to lie.

More than one stiff non-woven mat 12 may be added to a stack of stiff non-woven mats below the soft non-woven mat 14. An individual stiff non-woven mat 12 in a stack may be stacked upon another stiff non-woven mat without being fixed to the other. Fibers within the material of the mats may interlock between one mat and another. Alternatively, an individual stiff non-woven mat 12 in a stack may be connected to another stiff non-woven mat. Any suitable connection may be utilized. The connection may be through an adhesive. The connection may be through stitching. One or more of each of the stiff non-woven mats 12 in a stack may include one or more support pins.

An additional embodiment provides a support structure for placing under stiff non-woven mat 12. Supports or any other structure below bed pad 10 may be configured to provide air flow, which could facilitate drying of the mats. An embodiment includes a bed pad 10 positioned on a frame having open sections allowing air flow to the bottom of the bed pad 10. The particular configuration of the support structure could be geometrical or patterned, such as, but not limited to, a waffle-like pattern, a honey-comb pattern, egg-crate-like geometry, a tessellation pattern, a series of aligned slats configured in a frame for the bed pad 10, or any combination thereof. The supports or any other structure may be a layer 18 and/or a bed 16 as illustrated in FIG. 1.

The stiff non-woven mat(s) 12 and soft non-woven mat 14 may be constructed to be fire resistant or fire proof.

The stiff non-woven mat 12 may be ½″-2″ thick, and is made from fibers having a high denier and a stiff water based phenolic or latex binder. The denier for mat 12 may be 200, 100-200, or a value within any two integers selected from 100-500. The denier may be higher. A blend of different denier may be used in mat 12. The blend may be used to achieve the proper performance characteristics of the mat 12. The stiff non-woven mat 12 generally will only compress slightly under an average body weight so that the net free area is largely unaffected, and should have an elastic recovery of 75%-100%. The soft non-woven mat may be ⅜″-2″ thick and may be made from relatively fine denier fiber, for example less than or equal to 50 denier, 20 denier, or 6 denier, and is joined with a soft binder system, such as a soft latex binder so that it is soft and compresses, but still has a net free area for air circulation. A blend of different denier may be used in mat 14. The blend may be used to achieve the proper performance characteristics of the mat 14.

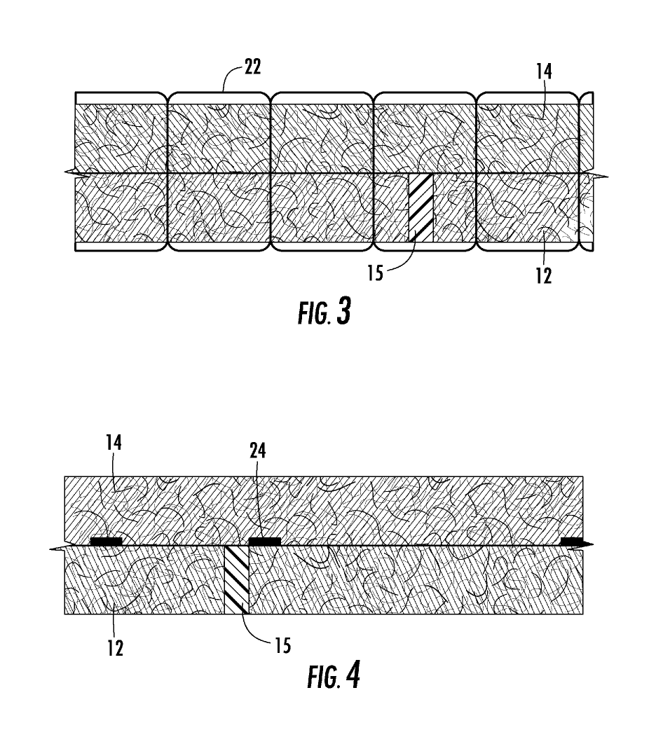

The stiff non-woven mat 12 may be connected to the soft non-woven mat 14 as shown in FIG. 3 or 4. This connection may be effected by stitching the mats together using a synthetic thread 22, as shown in FIG. 3. The mats can also be connected together by glue spots 24 or heat or friction welding at spaced apart locations, as shown in FIG. 4. It is also possible for the mats 12, 14 to be separable for ease of cleaning.

Referring again to FIG. 1, in use, a bed pad 10 could be positioned on a central location of a bed 16, on top of a removable moisture absorbing layer 18. The moisture absorbing layer 18 may be made of any suitable material able to protect the bed from moisture and able to be easily replaced. Optionally, a sheet 20 may be placed over a patient lying on the bed pad 10. The fine denier fibers of the soft non-woven mat 14 may be fine enough so that the occupant of the bed does not feel any discomfort, even without utilizing the sheet 20. A bed pad 10 may be, as described above, positioned on supports or any other structure below the bed pad 10 that are configured to provide air flow. The mattress of bed 16 may be plastic and may include material engineered to distribute body weight. The bed pad 10 may conform and work in concert with the design of bed 16 when the bed is designed to conform to or distribute the body weight of the patient. The bed pad 10 could be over a part, over substantially all of, or all of the surface of bed 10 or other support structure.

In an embodiment, the bed pad 10 may be cut to accommodate a specific patient's needs. It may be cut with a scissors or a knife.

The soft non-woven mat 14 compresses moderately under the loading of the occupant to allow a sufficient level of comfort while still maintaining a free area within the mat for air circulation and drainage of moisture. Under equal load, the stiff non-woven mat 12 compresses less than the soft non-woven mat 14, insuring that an adequate space exists between the occupant and the moisture absorbing layer 18. The synthetic fibers of the bed pad 10 do not absorb moisture, and fluids passing from the occupant travel through the bed pad 10. The fluid may be allowed to fall, be collected in a reservoir, or be absorbed (e.g., by absorbing layer 18). Therefore, the fluids remain out of contact with the occupant. The bed pad 10 remains air-permeable so that air flow circulates through the bed pad 10 to provide drying of residual moisture retained by the occupant.

The bed pad 10 may be disposed of after each use or it may be reused after cleaning. The bed pad 10 may be cleaned in an ethylene oxide sterilizer, although other methods of sterilization are readily apparent to those skilled in the art. The parts of bed pad 10 may be separated for cleaning and sterilization. A germicide, applied to or within the synthetic fibers during manufacturing, may help in controlling bacteria on the bed pad 10 and maintaining an acceptable level of sanitation.

The stiff and soft non-woven mats 12, 14 may be formed of a fiber mesh of a type that has been used in other applications for scrubbers and polishers. Synthetic fibers (usually nylon or polyester) are opened and blended, then randomly aligned into a web by airflow. The web is then treated with binding agents of water based phenolics and/or latexes. The treated web is then oven-cured to bind the fibers into a relatively rigid mat having a significant porous area between the random fibers.

The web is produced in dimensions adequate for the current application. It is apparent to those skilled in the art that other types of synthetic fibers and binding agents can be used to produce a comparable product with the qualities described above.

The mats may be flipped over and/or washed to recycle between uses. Different numbers of stiff non-woven mats 12 may be utilized based on the intended use or patient for the bed pad 10. The number and location of support pins in each stiff non-woven mat 12 in a bed pad 10 may be designed based on the intended use or patient for the bed pad 10. A bed pad 10 system may include a collection of the individual parts of bed pad 10 as described above that can be mixed and matched based on the intended use or patient for the bed pad 10. The collection may include stiff non-woven mats 12 with different numbers or configurations of support pins, different thicknesses, etc. The bed pad system 10 may include a chart indicating the how many each stiff non-woven mats 12 per weight of patient should be utilized. The bed pad system 10 may include a chart aligning the thickness of each stiff non-woven mats 12, the number many each stiff non-woven mats 12, and/or number/location of support pins per each stiff non-woven mat 12 with the intended use of bed pad 10 or weight of the intended patient.

The bed pad may be constructed by connecting the stiff non-woven mat 12 and the soft non-woven mat 14. The stiff non-woven mat 12 may be constructed by randomly aligning synthetic fibers which are opened and blended, randomly aligning the synthetic fibers into a web by airflow, joining the synthetic fiber by water based phenolic or latex binding agents, and heat curing the synthetic fibers to produce an air-permeable varying mesh. The stiff non-woven mat 12 may be a unitary sheet construction having no dissimilar sheets laminated or otherwise bonded together, and has a first stiffness. The soft non-woven mat 14, cooperative with the stiff non-woven mat 12, may be constructed by randomly aligning synthetic fibers which are opened and blended, randomly aligning the synthetic fibers into a web by airflow, joining the synthetic fibers by water based phenolic or latex binding agents, and heat curing the synthetic fibers to produce an air-permeable varying mesh. The soft non-woven mat 14 may be a unitary sheet construction having no dissimilar sheets laminated or otherwise bonded together, and has a second stiffness less than the first stiffness.

Those of ordinary skill in the art may recognize that many modifications and variations of the above may be implemented without departing from the spirit or scope of the following claims. Thus, it is intended that the following claims cover the modifications and variations provided they come within the scope of the appended claims and their equivalents.

What is claimed is:

1. A bed pad comprising:
a first mat constructed of randomly aligned synthetic fibers which are opened and blended, randomly aligned into a web by airflow, joined by water based phenolic or latex binding agents and heat cured to produce an air-permeable varying mesh, the first mat being of unitary sheet construction and having a first stiffness; and
a second mat, cooperative with the first mat, constructed of randomly aligned synthetic fibers which are opened and blended, randomly aligned into a web by airflow, joined by water based phenolic or latex binding agents and heat cured to produce an air-permeable varying mesh, the second mat being of unitary sheet construction and having a second stiffness less than the first stiffness.

2. The bed pad of claim 1, wherein the bed pad has a top and a bottom, and the first mat is below the second mat.

3. The bed pad of claim 1, further comprising:
at least one support pin within the first mat oriented substantially vertically with respect to the top and the bottom of the bed pad.

4. The bed pad of claim 3, wherein a number of support pins within the first mat is determined based on a size and a weight of a patient utilizing the bed pad.

5. The bed pad of claim 1, wherein the first mat and the second mat are connected using an adhesive.

6. The bed pad of claim 1, wherein the first mat and the second mat are stitched together.

7. The bed pad of claim 1, wherein an antimicrobial agent is within the fibers of at least one of the first mat or the second mat.

8. The bed pad of claim 1, wherein the bed pad is made up of recycled plastic.

9. The bed pad of claim 1, wherein the bed pad includes biodegradable fibers.

10. The bed pad of claim 1, wherein the first mat and the second mat are fire proof.

11. The bed pad of claim 1, wherein the second mat includes fibers having silicone.

12. The bed pad of claim 1, wherein the second mat includes a surface having lubricant.

13. A bed pad system comprising a collection of individual parts of a bed pad, wherein the individual parts include:
at least one first mat constructed of randomly aligned synthetic fibers which are opened and blended, randomly aligned into a web by airflow, joined by water based phenolic or latex binding agents and heat cured to produce an air-permeable varying mesh, the first mat being of unitary sheet construction and having a first stiffness; and
at least one second mat, cooperative with the first mat, constructed of randomly aligned synthetic fibers which are opened and blended, randomly aligned into a web by airflow, joined by water based phenolic or latex binding agents and heat cured to produce an air-permeable varying mesh, the second mat being of unitary sheet construction and having a second stiffness less than the first stiffness.

14. The bed pad system of claim 13, further comprising:
a bed configured to support the bed pad.

15. The bed pad system of claim 13, further comprising:
a support structure configured to be beneath the first mat and the second mat and including at least one opening to allow air flow to the first mat and second mat.

16. The bed pad system of claim 13, further comprising:
a chart indicating how many of the at least one first mat to include in the bed pad per weight of a patient.

17. A method for constructing a bed pad, the method comprising:
connecting a first mat and a second mat;
wherein the first mat is constructed by:
randomly aligning synthetic fibers which are opened and blended;
randomly aligning the synthetic fibers into a web by airflow;
joining the synthetic fiber by water based phenolic or latex binding agents; and
heat curing the synthetic fibers to produce an air-permeable varying mesh,
wherein the first mat is a unitary sheet construction having no dissimilar sheets laminated or otherwise bonded together, and has a first stiffness; and
wherein the second mat, cooperative with the first mat, is constructed by:
randomly aligning synthetic fibers which are opened and blended;
randomly aligning the synthetic fibers into a web by airflow;
joining the synthetic fibers by water based phenolic or latex binding agents; and
heat curing the synthetic fibers to produce an air-permeable varying mesh;
wherein the second mat is a unitary sheet construction having no dissimilar sheets laminated or otherwise bonded together, and has a second stiffness less than the first stiffness.

18. The method of claim 17, further comprising:
connecting the first mat and the second mat by at least one of an adhesive or stitching.

19. The method of claim 17, further comprising:
inserting at least one support pin within the first mat, wherein the at least one support pin is oriented substantially vertically with respect to the top and the bottom of the bed pad after inserting.

20. The method of claim 17, further comprising:
placing the bed pad on either a bed or a support structure, wherein the support structure includes an opening to allow air flow to the first mat and the second mat.
